(19) United States
(12) Patent Application Publication
(10) Pub. No.: US 2009/0091261 A1
(43) Pub. Date: Apr. 9, 2009

(54) Plasma display panel

(76) Inventors: Hyo-Suk Lee, Suwon-si (KR); Jae-Hyung Kim, Suwon-si (KR); Yun-Tae Hwang, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/217,405

(22) Filed: Jul. 3, 2008

(30) Foreign Application Priority Data
Oct. 4, 2007 (KR) 10-2007-0099797

(51) Int. Cl. H01J 17/49

(52) U.S. Cl. 313/582

(57) ABSTRACT

The present embodiments relate to a plasma display panel (PDP) for preventing a chemical reaction between a rear substrate of a sodalime glass including SiO₂—CaO—Na₂O and an address electrode including silver (Ag), and reducing a manufacturing cost. The PDP includes first and second substrates separately provided to face each other, a barrier rib, a phosphor layer, an address electrode, and first and second electrodes. The barrier rib is provided between the first and second substrates to partition discharge cells. The phosphor layer is formed in each discharge cell. The address electrode extends from the first substrate in a first direction. The first and second electrodes extend from the second substrate in a second direction crossing the first direction, and are arranged in parallel in the discharge cell along the first direction. The first substrate is formed of a sodalime glass including SiO₂—CaO—Na₂O, and the address electrode includes a frit layer formed of frit on the first substrate, and a metal layer formed of metal components on the frit layer.

### CROSS-REFERENCE TO RELATED APPLICATION

This application claims priority to and the benefit of Korean Patent Application No. 10-2007-0099797 filed in the Korean Intellectual Property Office on Oct. 4, 2007, the entire contents of which are incorporated herein by reference.

### BACKGROUND OF THE INVENTION

1. Field of the Invention

The present embodiments relate to a plasma display panel (PDP). More particularly, the present embodiments relate to a plasma display panel (PDP) for preventing a chemical reaction caused between SiO₂—CaO—Na₂O of a sodalime glass and metal components of an electrode.

2. Description of the Related Art

A plasma display panel (PDP) is a display element for realizing an image by gas discharge. The gas discharge generates plasma, the plasma radiates vacuum ultraviolet (VUV) rays, the VUV rays excite phosphors, and the excited phosphors are stabilized to generate red (R), green (G), and blue (B) visible light.

For example, in an alternating current (AC) PDP, an address electrode is formed on a rear substrate, and a dielectric layer is formed on the rear substrate while covering the address electrodes. Barrier ribs are formed in a stripe pattern on the dielectric layer between the respective address electrodes. Red (R), green (G), and blue (B) phosphor layers are formed on inner surfaces of the barrier ribs.

Display electrodes (e.g., a sustain electrode and a scan electrode formed in pairs) are formed on a front substrate in a direction crossing the address electrodes. The dielectric layer and a MgO protective layer are accumulated on an inner surface of the front substrate to cover the display electrodes.

Discharge cells are partitioned by the barrier ribs, and are formed at crossing regions of the address electrodes and the display electrodes. Accordingly, millions or more of the discharge cells are arranged in a matrix format in the PDP.

To reduce manufacturing cost of the PDP, the front substrate and the rear substrate may be formed of a sodalime glass including SiO₂—CaO—Na₂O. In addition, to improve electrical conductivity, the address electrode and the display electrode may include metal components (e.g., silver (Ag)).

When a low-cost sodalime glass is used as the rear substrate and the address electrode including the silver (Ag) is formed on the rear substrate, a chemical reaction can occur between SiO₂—CaO—Na₂O of the rear substrate and the silver of the address electrode. As a result, the color of a display area of the rear substrate is changed, and the shape of the rear substrate is transformed by heat.

To prevent the variations of color and shape of the rear substrate, an insulation layer is formed between the rear substrate and the address electrode. The insulation layer prevents the chemical reaction between the SiO₂—CaO—Na₂O and the metal component, but it is required to perform an insulation layer forming process and an address electrode forming process. Accordingly, manufacturing cost of the PDP increases.

Therefore, the manufacturing cost that is reduced by forming the sodalime glass as the rear substrate is offset since the insulation layer is additionally formed.

The above information disclosed in this background section is only provided for enhancement of understanding of the background of the present embodiments and therefore it may contain information that does not form the prior art that is already known in this country to a person of ordinary skill in the art. Also, the present embodiments overcome the above problems in the art as well as provide additional advantages.

### SUMMARY OF THE INVENTION

The present embodiments provide a plasma display panel (PDP) for preventing a chemical reaction between a rear substrate of a sodalime glass including SiO₂—CaO—Na₂O and an address electrode including silver (Ag), and to prevent variations of color and shape of a rear substrate on a display area.

In addition, the present embodiments provide a plasma display panel (PDP) for preventing a chemical reaction between a rear substrate of a sodalime glass including SiO₂—CaO—Na₂O and an address electrode including silver (Ag), and reducing manufacturing cost.

According to an exemplary embodiment, a plasma display panel (PDP) includes first and second substrates separately provided to face each other, a barrier rib, a phosphor layer, an address electrode, and first and second electrodes. The barrier rib is provided between the first and second substrates to partition discharge cells. The phosphor layer is formed in the discharge cell. The address electrode extends from the first substrate in a first direction. The first and second electrodes extend from the second substrate in a second direction crossing the first direction, and are arranged in parallel in the discharge cell along the first direction. The first substrate is formed of a sodalime glass including SiO₂—CaO—Na₂O, and the address electrode includes a frit layer formed of frit on the first substrate and a metal layer formed of metal components on the frit layer.

The frit layer has a predetermined first width, the metal layer has a predetermined second width, and the first width may be greater than the second width.

The metal layer may form a conductive line, and the frit layer may form first and second insulation lines on both sides of the conductive line.

On an incision surface in a direction perpendicularly crossing a length direction of the address electrode, the frit layer may cover side surfaces of the metal layer.

An irregular curved line of protrusions and depressions may be formed on the side surfaces of the metal layer, an inner surface of the frit layer may fill the protrusions and depressions, and an outer surface of the frit layer may form a sloped surface toward the first substrate from an upper part of the metal layer.

The metal layer may include silver (Ag).

The frit layer may include at least one of SiO₂, PbO, Bi₂O₃, ZnO, B₂O₃, and BaO.

A weight ratio of the metal components and the frit may be 52 to 62:5 to 15, the frit may include B₂O₃ and BaO, and a weight ratio of the BaO to the B₂O₃ is greater than 1.

The weight ratio of the BaO to B₂O₃ may be within a range between 1 and 5.

The frit may further include a coating layer for filling open pores on the metal layer to coat the metal layer.

The coating layer has a second thickness that is thinner than the first thickness of the frit layer. 100251 The first substrate may be a rear substrate, and the second substrate may be a front substrate.

According to another exemplary embodiment, a plasma display panel (PDP) includes a front substrate, a rear substrate, a barrier rib, a phosphor layer, an address electrode, and first and second electrodes. The rear substrate is separately provided from the front substrate such that they face each other, and is formed of a sodalime glass including SiO₂—CaO—Na₂O. The barrier rib is provided between the front and rear substrates to partition discharge cells. The phosphor layer is formed in the discharge cells. The address electrode extends in a first direction from the rear substrate, and is formed by coating silver particles with frit. The first and second electrodes extend from the front substrate in a second direction crossing the first direction, and are arranged in parallel in the discharge cell along the first direction. On an incision surface in a direction perpendicularly crossing a length direction of the address electrode, the silver particles may form an irregular curved line of protrusions and depressions on a side surface of the address electrode, and the frit may fill the protrusions and depressions on the inside of the side surface of the address electrode and may form a sloped surface connecting the first substrate and an upper part of the metal layer on the outside of the side surface.

The frit may include a frit layer of a first thickness between the silver particles and the rear substrate, and a coating layer of a second thickness to fill and coat open pores on an upper surface of the silver particles. The first thickness is greater than the second thickness.

In the PDP according to the exemplary embodiment, an address electrode including metal components is formed on a sodalime glass substrate including SiO₂—CaO—Na₂O, a frit layer of the address electrode is disposed on the sodalime glass substrate, and a metal layer is disposed on the frit layer, and therefore chemical reaction between the sodalime glass substrate and the address electrode may be prevented.

Since the frit layer prevents the chemical reaction between the sodalime glass substrate and the address electrode, variations of color and shape of the sodalime glass substrate on a display area may be prevented.

In addition, since the frit layer forming the address electrode prevents the chemical reaction between SiO₂—CaO—Na₂O and silver, it is not required to provide an additional insulation layer between the sodalime glass substrate and the address electrode, and therefore manufacturing cost may be reduced.

### BRIEF DESCRIPTION OF THE DRAWINGS

FIG. 1 is an exploded perspective view of a plasma display panel (PDP) according to an exemplary embodiment.

FIG. 2 is a cross-sectional view along a line II-II shown in FIG. 1.

FIG. 3 is a top plan view representing an arrangement of electrodes and discharge cells.

FIG. 4 is a top plan view representing an expanded address electrode.

FIG. 5 is a cross-sectional view along a line V-V shown in FIG. 4,

### DESCRIPTION OF REFERENCE NUMERALS INDICATING ELEMENTS IN THE DRAWINGS

10: First substrate (Rear substrate)

20: Second substrate (Front substrate)

13, 21: First and second dielectric layers

16: Barrier rib

17: Discharge cell

19: Phosphor layer

23: Protective layer

11: Address electrode

31: First electrode (Sustain electrode)

32: Second electrode (Scan electrode)

31a, 32a: Transparent electrode

31b, 32b: Bus electrode

W31, W32: Width

DG: Discharge gap

111: Frit layer

112: Metal layer

113: Coating layer

112a: Conductive line

111a, 111b: First and second insulation lines

W111, W112: First and second widths

T1, T2: First and second thicknesses

### DETAILED DESCRIPTION OF THE EMBODIMENTS

The present embodiments will be described more fully hereinafter with reference to the accompanying drawings, in which exemplary embodiments are shown. As those skilled in the art would realize, the described embodiments may be modified in various ways, all without departing from the spirit or scope of the present embodiments. Accordingly, the drawings and description are to be regarded as illustrative in nature and not restrictive. Like reference numerals designate like elements throughout the specification.

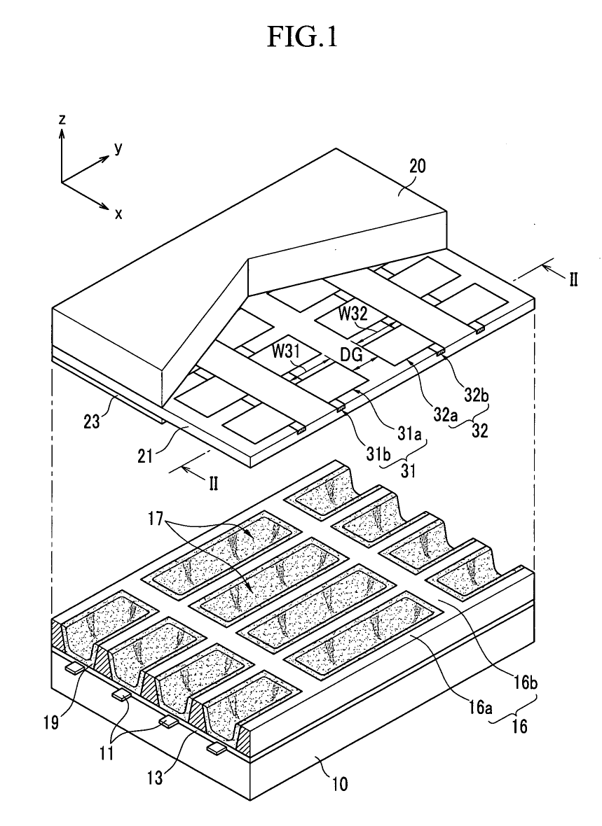

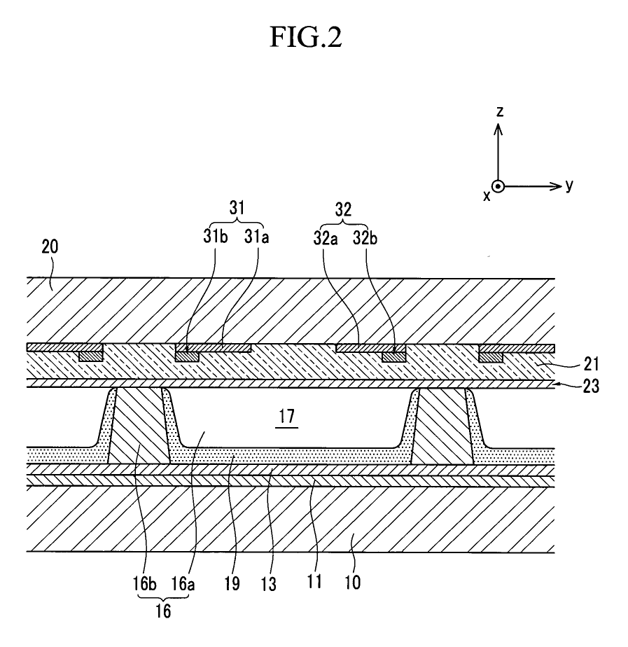

FIG. 1 is an exploded perspective view of a plasma display panel (PDP) according to an exemplary embodiment, and FIG. 2 is a cross-sectional view along a line II-II shown in FIG. 1.

As shown in FIG. 1 and FIG. 2, a PDP according to an exemplary embodiment includes rear and front substrates 10 and 20 that face each other and are sealed together. Barrier ribs 16 are formed between the rear and front substrates 10 and 20.

The rear substrate 10 and the front substrate 20 may be formed of glass substrates including an alkali component. For example, one or both of the rear and front substrates 10 and 20 may be formed of sodalime glass including SiO₂—CaO—Na₂O. Since the cost of the sodalime glass is low, manufacturing cost of the PDP is reduced.

The barrier rib 16 partitions a plurality of discharge cells 17 between the rear and front substrates 10 and 20. A discharge gas (e.g., a mixed gas of neon (Ne) and xenon (Xe)) is filled in the discharge cells 17 to generate vacuum ultraviolet (VUV) rays by gas discharge, and a phosphor layer 19 is formed to absorb the VUV rays and radiate visible light.

To realize an image by the gas discharge, the PDP includes an address electrode 11, a first electrode 31 (hereinafter referred to as a sustain electrode), and a second electrode 32 (hereinafter referred to as a scan electrode) that are disposed to correspond to the discharge cell 17 between the rear and front substrates 10 and 20.

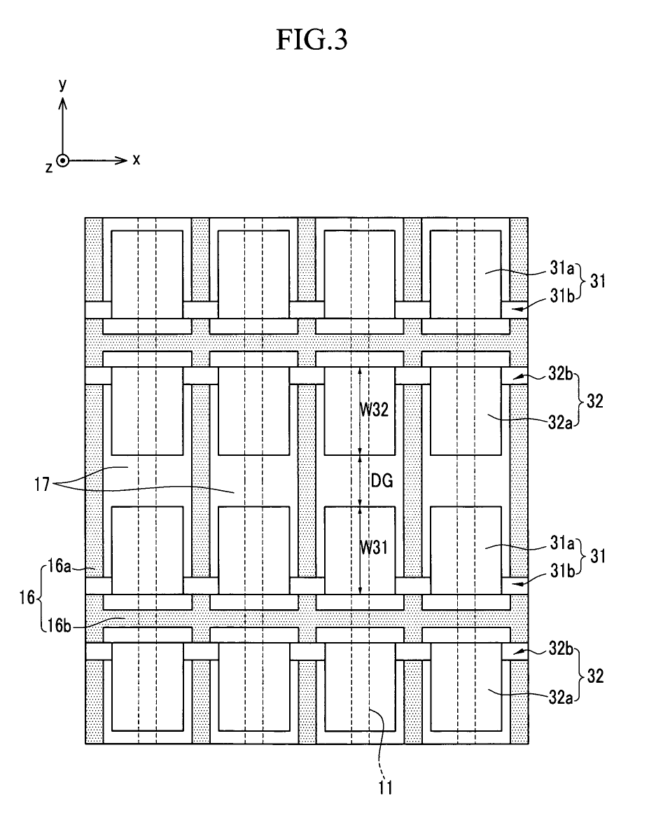

FIG. 3 is a top plan view representing an arrangement of electrodes and discharge cells.

Referring to FIG. 3, one address electrode 11 is formed on an inner surface of the rear substrate 10 while extending along a first direction (i.e., a y-axis direction) to sequentially correspond to the discharge cells neighboring in the y-axis direction. In addition, a plurality of address electrodes 11 are arranged in parallel along a second direction (i.e., an x-axis direction) crossing the y-axis direction.

Referring to FIGS. 1 and 2, a first dielectric layer 13 covers inner surfaces of the address electrodes 11 and the rear substrate 10. The first dielectric layer 13 prevents positive ions or electrons from directly colliding with the address electrode 11, so that the address electrode 11 may be prevented from being damaged. In addition, the first dielectric layer 13 provides spaces for forming and accumulating wall charges.

Since the address electrode 11 is disposed on the rear substrate 10 so that visible light may not be prevented from being irradiated forward, the address electrode 11 may be formed as an opaque electrode. For example, the address electrode 11 may be formed as a metal electrode (e.g., an electrode including silver (Ag)) having excellent electrical conductivity.

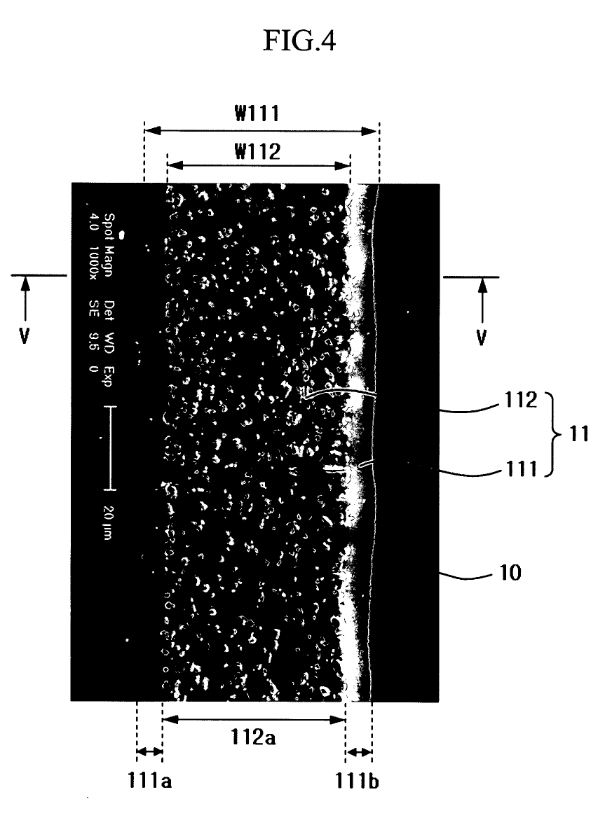

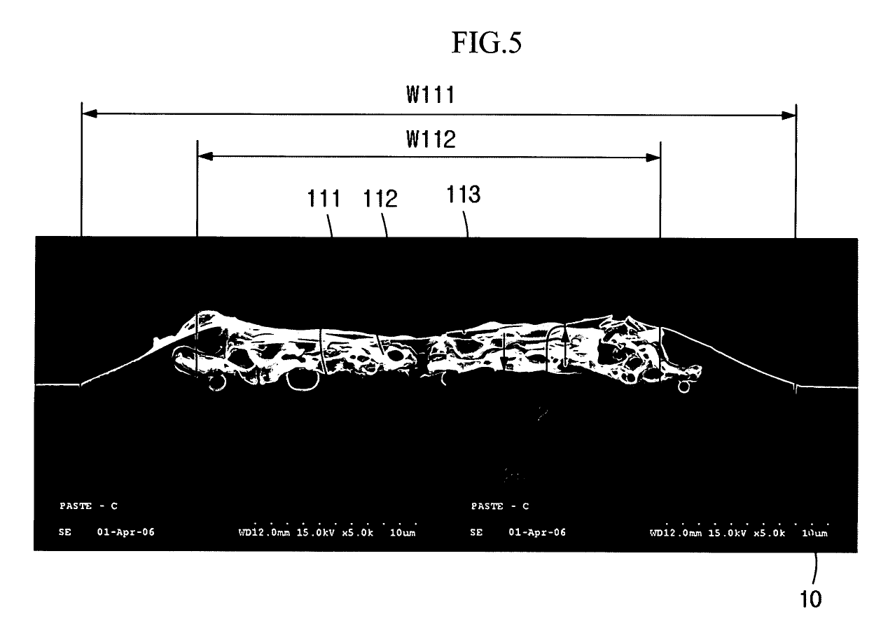

FIG. 4 is a top plan view representing an expanded address electrode, and FIG. 5 is a cross-sectional view along a line V-V shown in FIG. 4.

As shown in FIG. 4 and FIG. 5, the address electrode 11 includes a frit layer 111 formed of frit and a metal layer 112 formed of metal on the rear substrate 10.

A paste in which metal components of metal particles and frit are mixed is printed or coated on the rear substrate 10 and is then dried and baked to form the address electrode 11.

When the paste is printed, dried, and baked, the frit forms the frit layer 111 on the rear substrate 10, and the metal components form the metal layer 112 on the frit layer 111. The metal components may comprise silver (Ag) particles, for example.

Referring to FIG. 4, in a drying and baking process, the frit layer 111 forms a predetermined first width W111, and the metal layer 112 forms a predetermined second width WI 12. The first width W111 is greater than the second width W112.

In the address electrode 11, the metal layer 112 of the second width W112 forms a conductive line 112a, and the frit layer 111 forms a first insulation line 111a and a second insulation line 111b on both sides of the conductive line 112a.

The first insulation line 111a and the second insulation line 111b prevent the conductive lines 112a of the neighboring address electrodes 11 from being connected.

Referring to FIG. 5, the frit layer 111 is formed to surround both side surfaces of the metal layer 112. In the metal layer 112, a side surface is formed as an irregular curved line of protrusions and depressions.

An inner surface of the frit layer 111 fills the protrusions and depressions of the metal layer 112, and an outer surface thereof forms a sloped surface toward the rear substrate 10 from an upper part of the metal layer 112.

Since the inner surface of the frit layer 111 fills the protrusions and depressions of the metal layer 112, the frit surrounds the side surface of the metal layer 112.

Since the frit layer 111 on the side surface of the metal layer 112 tightly adheres the metal layer 112 to the rear substrate 10, an edge curl occurs on the side surface of the metal layer 112.

The frit layer 111 may be formed of insulation materials including at least one of SiO₂, PbO, Bi₂O₃, ZnO, B₂O₃, and BaO.

The weight ratio of the metal components forming the metal layer 112 and the frit forming the frit layer 111 is from about 52 to about 62:from about 5 to about 15. The frit can include B₂O₃ and BaO, and in some example, the weight ratio of the BaO to the B₂O₃ may be greater than about 1. In some examples, the weight ratio of the BaO to the B₂O₃ is from about 1 to about 5.

The frit is mixed with the metal component of the metal layer 112 to combine the metal particles, and liquid sintering is difficult since the glass forming temperature increases when the weight ratio of the BaO to the B₂O₃ is less than 1, and electrical conductivity is reduced when the weight ratio is greater than 5. The frit may include SiO₂, PbO, Bi₂O₃, or ZnO, for example.

Referring to FIG. 4, the frit further includes a coating layer 113 for filling open pores on the metal layer 112 to coat the metal layer 112. After the frit that is mixed with the metal component is printed, dried, and baked, the frit does not completely come out from the metal component and fills in the pores in the metal layer 112.

The frit layer 111 has a first thickness T1, and the coating layer 113 has a second thickness T2. The first thickness T1 is greater than the second thickness T2. As shown in FIG. 5, compared to the first thickness T1, the second thickness T2 is thin such that the second thickness may not be partially illustrated on the metal layer 112. For convenience, the second thickness T2 is illustrated on the partially formed coating layer 113.

The frit layer 111 prevents a chemical reaction between the metal layer 112 and the rear substrate 10. That is, the frit layer 111 prevents the chemical reaction between SiO₂—CaO—Na₂O of the sodalime glass and the metal layer 112. Accordingly, the color and shape of the rear substrate 10 at a display area may not be changed.

In addition, since the frit layer 111 is concomitantly formed when the address electrode is formed, manufacturing cost is reduced.

The coating layer 113 along with the first dielectric layer 13 covering the address electrode 11 covers the metal layer 112. Accordingly, the coating layer 113 protects the metal layer 112, and provides more spaces for forming and accumulating the wall charges.

In the exemplary embodiment, an electrode having the metal layer 112 and the frit layer 111 is applied to the address electrode 11, and the address electrode 11 is disposed on the rear substrate 10 formed of the sodalime glass.

In addition, when the address electrode is formed on the front substrate, the address electrode may be formed of the metal layer and the frit layer (not shown).

Further, the electrode having the metal layer and the frit layer may be applied to the sustain electrode and the scan electrode (e.g., when the sustain electrode and the scan electrode are formed by the metal electrode), the sustain electrode and the scan electrode may be applied to the front substrate or the rear substrate (not shown).

For example, the electrode having the metal layer 112 and the frit layer 111 can be applied to any sodalime glass substrate including SiO₂—CaO—Na₂O. Therefore, the frit layer 111 forming an electrode prevents the chemical reaction between the metal layer 112 and the SiO₂—CaO—Na₂O of the glass substrate.

In addition, referring to FIGS. 1-3, the barrier rib 16 is provided on the first dielectric layer 13 to partition the discharge cells 17. For example, the barrier rib 16 includes first barrier rib members 16a extending in a y-axis direction and second barrier rib members 16b extending between the first barrier rib members 16a in an x-axis direction to form the discharge cells 17 in a matrix format.

Further, the barrier rib may be formed as the first barrier rib member extending in the y-axis direction to form the discharge cells in a stripe pattern (not shown). That is, the discharge cells are open along the y-axis direction.

In an exemplary embodiment, the barrier rib 16 forming the discharge cells 17 in a matrix format is illustrated. In this case, when the second barrier rib members 16b are eliminated, the discharge cells are formed in a stripe pattern by the first barrier rib members 16a. Accordingly, illustration of the discharge cells in the stripe pattern is omitted.

In the respective discharge cells 17, a phosphor paste is coated, dried, and baked on a surface of the first dielectric layer 13 positioned between the barrier ribs 16 and a side surface of the barrier rib 16 to form the phosphor layer 19.

The phosphor layers 19 have the same color phosphor with respect to the discharge cells 17 formed along the y-axis direction. In addition, red R, green G, and blue B phosphors are sequentially formed in the phosphor layers 19 with respect to the discharge cells 17 sequentially disposed along the x-axis direction.

The sustain electrode 31 and the scan electrode 32 are formed on the inner surface of the front substrate 20 so as to maintain a surface discharge configuration with respect to the respective discharge cells 17. Referring to FIG. 3, the sustain electrode 31 and the scan electrode 32 are formed along the x-axis direction crossing the address electrode 11.

The sustain electrode 31 and the scan electrode 32 respectively include transparent electrodes 31a and 32a for generating discharges, and bus electrodes 31b and 32b for applying a voltage signal to the transparent electrodes 31a and 32a.

The transparent electrodes 31a and 32a generate surface discharges in the discharge cell 17, and are formed of transparent materials (e.g., indium tin oxide (ITO)) to obtain an aperture ratio of the discharge cell 17.

The bus electrodes 31b and 32b are formed of metal materials having excellent electrical conductivity to compensate for the high electrical resistance of the transparent electrodes 31a and 32a.

The transparent electrodes 31a and 32a respectively form the surface discharge configuration while having widths W31 and W32 from a contour to a center of the discharge cell 17 along the y-axis direction, and a discharge gap DG is formed at a center part of each discharge cell 17.

The bus electrodes 31b and 32b are respectively disposed on the transparent electrodes 31a and 32a, and extend along the x-axis direction at the contour of the discharge cell 17. Accordingly, when the voltage signal is applied to the bus electrodes 31b and 32b, the voltage signal is applied to the transparent electrodes 31a and 32a respectively connected to the bus electrodes 31b and 32b.

In addition, as shown in FIG. 1 to FIG. 3, the transparent electrode may be separately formed to correspond to each discharge cell 17, and the transparent electrode may be integrally formed along the x-axis direction (not shown).

Referring again to FIG. 3, the sustain electrode 31 and the scan electrode 32 correspond to the discharge cell 17 while crossing the address electrodes 11, and the sustain electrode 31 and the scan electrode 32 face each other.

A second dielectric layer 21 covers the inner surfaces of the front substrate 20, the scan electrode 32, and the sustain electrode 31. The second dielectric layer 21 protects the sustain electrode 31 and the scan electrode 32 from the gas discharge, and provides the space for forming and accumulating the wall charges when the discharge is generated.

A protective layer 23 is formed on the second dielectric layer 21 to cover the second dielectric layer 21. For example, the protective layer 23 can comprise MgO, which protects the second dielectric layer 21, and emits secondary electrons when the discharge is generated.

When the PDP is driven, a reset discharge is generated by a reset pulse applied to the scan electrode 31 during a reset period. An address discharge is generated by an address pulse applied to the address electrode 11 and a scan pulse applied to the scan electrode 32 during a scan period (address period) that is subsequent to the reset period. Subsequently, during a sustain period, a sustain discharge is generated by a sustain pulse applied to the sustain electrode and the scan electrode 32.

The sustain electrode 31 and the scan electrode 32 apply the sustain pulse required to generated the sustain discharge. The scan electrode 32 applies the reset pulse and the scan pulse. The address electrode 11 applies the address pulse.

Since functions of the sustain electrode 31, the scan electrode 32, and the address electrode 11 may vary according to applied voltage waveforms, they are not limited thereto.

The PDP selects turn-on discharge cells 17 by the address discharge caused by a reciprocal action between the address electrode 11 and the scan electrode 32, and realizes an image by the sustain discharge by a reciprocal action between the sustain electrode and the scan electrode 32 in the selected discharge cells 17.

While these embodiments have been described in connection with what is presently considered to be practical exemplary embodiments, it is to be understood that the embodiments are not limited to the disclosed embodiments, but, on the contrary, is intended to cover various modifications and equivalent arrangements included within the spirit and scope of the appended claims.

What is claimed is:

1. A plasma display panel (PDP) comprising:
first and second substrates facing each other;
a barrier rib provided between the first and second substrates to partition discharge cells;
a phosphor layer formed in the discharge cells;
an address electrode extending from the first substrate in a first direction; and
first and second electrodes that extend from the second substrate in a second direction crossing the first direction, and arranged in parallel in the discharge cell along the first direction,
wherein the first substrate is formed of a sodalime glass including SiO₂—CaO—Na₂O, and
the address electrode comprises a frit layer formed of frit on the first substrate and a metal layer formed of metal components on the frit layer.

2. The PDP of claim 1, wherein the frit layer has a predetermined first width, the metal layer has a predetermined second width, and the first width is greater than the second width.

3. The PDP of claim 2, wherein the metal layer forms a conductive line, and the frit layer forms first and second insulation lines on both sides of the conductive line.

4. The PDP of claim 2, wherein, on an incision surface in a direction perpendicularly crossing the length direction of the address electrode, the frit layer covers side surfaces of the metal layer.

5. The PDP of claim 4, wherein an irregular curved line of protrusions and depressions is formed on the side surfaces of the metal layer,
wherein an inner surface of the frit layer fills the protrusions and depressions, and
wherein an outer surface of the frit layer forms a sloped surface toward the first substrate from an upper part of the metal layer.

6. The PDP of claim 1, wherein the metal layer comprises silver (Ag).

7. The PDP of claim 6, wherein the frit layer comprises at least one of SiO2, PbO, Bi2O3, ZnO, B2O3, and BaO.

8. The PDP of claim 1, wherein the weight ratio of the metal components and the frit is from about 52 to about 62:from about 5 to about 15,
wherein the frit comprises B₂O₃ and BaO, and
wherein the weight ratio of the BaO to the B₂O₃ is greater than 1.

9. The PDP of claim 8, wherein the weight ratio of the BaO to B₂O₃ is from about 1 to about 5.

10. The PDP of claim 1, wherein the frit further comprises a coating layer for filling open pores on the metal layer to coat the metal layer.

11. The PDP of claim 10, wherein the coating layer has a second thickness that is thinner than the first thickness of the frit layer.

12. The PDP of claim 1, wherein the first substrate is a rear substrate, and the second substrate is a front substrate.

13. A plasma display panel (PDP) comprising:
a front substrate;
a rear substrate that faces the front substrate, and is formed of a sodalime glass including SiO₂—CaO—Na₂O;
a barrier rib provided between the front and rear substrates to partition discharge cells;
a phosphor layer formed in the discharge cells;
an address electrode that extends in a first direction from the rear substrate, and is formed by coating silver particles with frit; and
first and second electrodes that extend from the front substrate in a second direction crossing the first direction, and are arranged in parallel in the discharge cell along the first direction.

14. The PDP of claim 13, wherein, on an incision surface in a direction perpendicularly crossing a length direction of the address electrode, the silver particles form an irregular curved line of protrusions and depressions on a side surface of the address electrode, and the frit fills the protrusions and depressions on the inside of the side surface of the address electrode, and forms a sloped surface connecting the first substrate and an upper part of the metal layer on the outside of the side surface.

15. The PDP of claim 13, wherein the frit comprises at least one of SiO₂, PbO, Bi₂O₃, ZnO, B₂O₃, and BaO.

16. The PDP of claim 15, wherein the frit comprises a frit layer of a first thickness between the silver particles and the rear substrate, and a coating layer of a second thickness to fill and coat open pores on an upper surface of the silver particles.

17. The PDP of claim 16, wherein the first thickness is greater than the second thickness.

18. The PDP of claim 1, further comprising a protective layer.

19. The PDP of claim 18, wherein the protective layer comprises MgO.

20. The PDP of claim 13, further comprising a protective layer.

21. The PDP of claim 20, wherein the protective layer comprises MgO.
